(19) United States
(12) Patent Application Publication
(10) Pub. No.: US 2004/0131171 A1
(43) Pub. Date: Jul. 8, 2004

(54) Call center apparatus for automatically distributing call through public telephone network and controlling method for call center apparatus

(76) Inventor: Kazushige Haruta, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/628,776

(22) Filed: Jul. 28, 2003

Related U.S. Application Data
(63) Continuation of application No. 09/042,967, filed on Mar. 17, 1998, now abandoned.

(30) Foreign Application Priority Data
Oct. 17, 1997 (JP) 09-285064

(51) Int. Cl. H04M 5/00; H04M 3/00

(52) U.S. Cl. 379/265.02; 379/242

(57) ABSTRACT

A route table stores a control step for controlling an automatic call distribution (ACD) process for a termination call. A transfer destination telephone number table stores information with which a transfer destination telephone number is determined. When a control step in the route table is a transfer control step for instructing to transfer a termination call, a call controlling unit refers the transfer destination telephone number table, determines a transfer destination telephone number for the termination call, and transfers the termination call to the transfer destination telephone number using a termination call transfer service of a public telephone network to which public telephone lines are connected.

### BACKGROUND OF THE INVENTION

1. Field of the Invention

The present invention relates to a call distributing function of a call center system, in particular, to a technology for transferring a call between network type call centers operated on a plurality of sites or a technology for transferring a call to a home agent.

2. Description of the Related Art

As companies have downsized, network type call centers operated on a plurality of sites have been required instead of a centralized call center. Alternatively, home agents that operate as call centers have been required to collect calls instead of conventional call centers.

Thus, to optimally operate one call center by a plurality of sites rather than call centers by individual sites, an automatic call distribution (ACD) function for transferring a termination call for one site through a public telephone network to another site or to a subscriber telephone as a home agent is required.

In a conventional network type call center, ACD systems that are composed of PBXs (Private Branch Exchanges) and so forth are connected with dedicated lines. A termination call from the public telephone network to one PBX is transferred to another PBX through a dedicated line.

FIG. 1 is a schematic diagram showing the structure of a conventional network type call center.

For example, a PBX 101 (#1) that composes an ACD system is disposed on a site 1. The PBX 101 (#1) accommodates n1 public telephone lines 102 (#1) and m1 ACD agents 103 (#1) as extension lines.

On a site 2, a PBX 101 (#2) that composes an ACD system is disposed. The PBX 101 (#2) accommodates n2 public telephone lines 102 (#2) and m2 ACD agents 103 (#2) as extension lines.

The PBX 101 (#1) on the site 1 and the PBX 101 (#2) on the site 2 are connected with t (t channels) dedicated lines 105.

Normally, a termination call from a public telephone line 102 (#1) to the site 1 is terminated by the PBX 101 (#1) to one of the m1 ACD agents 103 (#1) accommodated in the PBX 101 (#1) corresponding to route steps 104 (#1) that are process data for controlling a termination call.

Likewise, a termination call from a public telephone line 102 (#2) to the site 2 is terminated by the PX 101 (#2) to one of the m2 ACD agents 103 (#2) accommodated in the PBX 101 (#2) corresponding to route steps 104 (#2).

However, in the case that the ml ACD agents 103 (#1) accommodated in the PBX 101 (#1) on the site 1 get congested and termination calls from the public telephone lines 102 (#1) are queued, if the ACD agents 103 (#2) accommodated in the PBX 101 (#2) on the site 2 can respond to the termination calls faster than ACD agents 103 (#1), the termination calls from the public telephone lines 102 (#1) to the PBX 101 (#1) on the site I are transferred to the PBX 101 (#2) on the site 2 through the dedicated lines 105.

With such a call distribution controlling operation, both the ACD agents 103 (#1) accommodated in the PBX 101 (#1) on the site 1 and the ACD agents 103 (#2) accommodated in the PBX 101 (#2) on the site 2 can be effectively used.

On the other hand, in the conventional home agents, termination calls from the public telephone network to the ACD system are transferred to home agents through an ACD system composed of a PBX and so forth.

FIG. 2 is a schematic diagram showing the structure of a conventional home agent.

For example, a PBX 201 that is an ACD system is disposed on a particular site. The PBX 201 accommodates n4 public telephone lines. A subscriber telephone with a subscriber telephone number DN1 operates as a home agent 203.

When the home agent 203 receives a call from a subscriber (not shown in FIG. 2), the subscriber originates a call to a representative telephone number of the PBX 201. Thus, when the PBX 201 receives a termination call from the subscriber through one public telephone line 202 of the public telephone network, the PBX 201 originates a call to the subscriber telephone with the subscriber telephone number DN1 through another public telephone line 202 and transfers the termination call to the home agent.

However, according to the related art reference of the network type call center shown in FIG. 1, in the case that the m1 ACD agents 103 (#1) accommodated in the PBX 101 (#1) on the site 1 gets congested and termination calls from the public telephone lines 102 (#1) are queued, although the ACD agents 103 (#2) accommodated in the PBX 101 (#2) on the site 2 can respond to the termination calls faster than ACD agents 103 (#1), when all the channels of the dedicated lines 105 are used, the termination calls to the site 1 cannot be transferred to the site 2.

Thus, in the above-described related art reference, there is an operational problem that how an optimum number of channels of dedicated lines 105 should be designated for reducing the probability of which all the channels of the dedicated lines 105 are used.

In the related art reference of the home agent shown in FIG. 2, when the PBX 201 transfers a termination call for a home agent 203, there is a problem that the PBX 201 use two public telephone lines at a time.

Thus, in the above-described related art reference, there is a problem that how many public telephone lines 202 accommodated in the PBX 201 should be properly designated corresponding to the number of the home agents 203.

### SUMMARY OF THE INVENTION

The present invention is made from the above-described point of view. An object of the present invention is to allow a termination call received from the public telephone network to be transferred to another ACD system or a home agent through the public telephone network using a termination call transfer service of the public telephone network rather than dedicated lines and a transfer function of a PBX.

The present invention is based on a call center apparatus for automatically distributing a call through the public telephone network.

A route table (route table 310) stores at least one control step for controlling an automatic call distributing (ACD) process for a termination call.

A call controlling processor (automatic call distribution controlling unit 309) successively executes each control step in the route table for a termination call and executes an automatic call distributing operation corresponding to each control step. When the executed control step is a transfer control step for instructing to transfer the termination call, the call controlling processor determines a transfer destination telephone number for the termination call designated at the transfer control step and transfers the termination call to the determined transfer destination telephone number using a termination call transfer service of the public telephone network.

In the above-mentioned structure of the present invention, a transfer destination telephone number table (transfer destination telephone number table 311) for storing information with which a transfer destination telephone number is designated is further included. Thus, when the executed control step is a transfer control step for instructing to transfer the termination call, the call controlling processor refers the transfer destination telephone number table, determines a transfer destination telephone number for the termination call, and transfers the termination call to the determined transfer destination telephone number using the termination call transfer service of the public telephone network.

In this case, the transfer destination telephone number table stores information with which the transfer destination telephone number is scheduled, for example, corresponding to date, day of week, and time zone.

In the above-mentioned structure of the present invention, an additional information database (customer database 312) for storing information with which the transfer destination telephone number is designated corresponding to additional information that is added to the termination call by the public telephone network is further included. Thus, when the executed control step is a transfer control step for instructing to transfer the termination call, the call controlling processor refers the additional information database corresponding to the additional information added to the termination call, determines a transfer destination telephone number for the termination call, and transfers the termination call to the determined transfer destination telephone number using the termination call transfer service of the public telephone network.

In the above-mentioned structure of the present invention, a system operation state table (System Operation State Table 313) for storing a system operation state of another call center apparatus is further included. Thus, when the executed control step is a transfer control step for instructing to transfer the termination call, the call controlling processor refers the system operation state table, determines an optimum transfer destination telephone number for the termination call, and transfers the termination call to the determined transfer destination telephone number using the termination call transfer service of the public telephone network.

In this case, a system operation state communication circuit (External Data Access Controlling Unit 314) for communicating the system operation state between the call center apparatus and another call center apparatus is further included.

In all of the above-mentioned structures of the present invention, when the executed control step is a transfer control step for instructing to transfer the termination call and when the transfer destination telephone number for the termination call designated at the transfer control step is corresponding to a private telephone network other than the public telephone network, the call controlling processor originates a call to the transfer destination telephone number on the private telephone network and transfers the termination call received from the public telephone network to the transfer destination telephone number on the private telephone network.

In addition, the present invention can be applied to a storage medium from which a computer for controlling a call center apparatus reads a program that causes the computer to perform functions that are the same as functions accomplished by each structure of the present invention.

### BRIEF DESCRIPTION OF THE DRAWINGS

These and other objects, features and advantages of the present invention will become more apparent in light of the following detailed description of a best mode embodiment thereof, as illustrated in the accompanying drawings.

FIG. 1 is a schematic diagram showing the structure of a conventional network type call center;

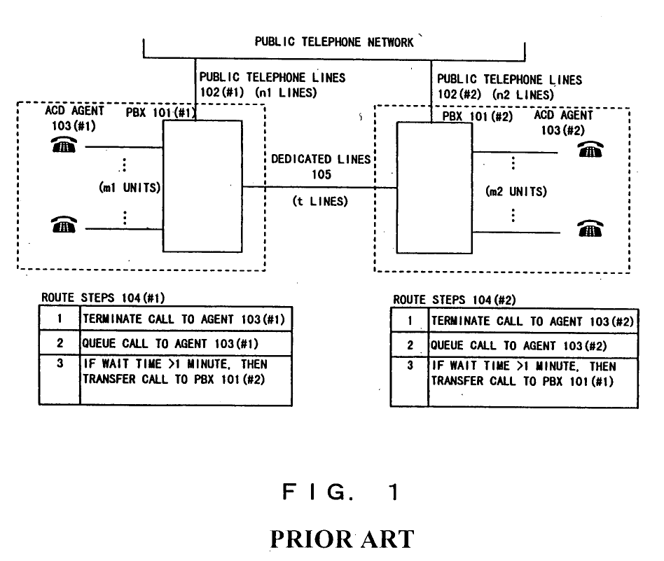

FIG. 2 is a schematic diagram showing the structure of a conventional home agent;

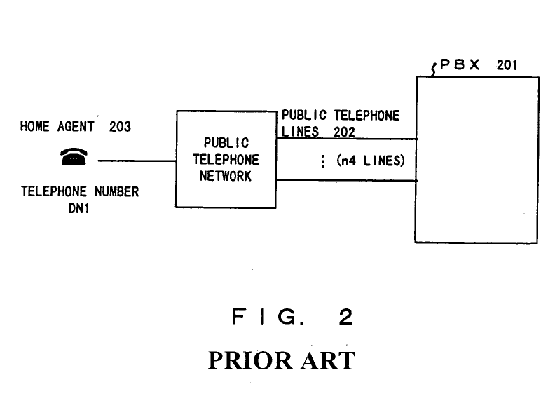

FIG. 3 is a schematic diagram showing the common system structure of each of embodiments of the present invention;

FIG. 4 is a schematic diagram showing the structure of a first embodiment of the present invention;

FIG. 5 is a flowchart showing a control operation of the first embodiment of the present invention;

FIG. 6 is a schematic diagram showing the structure of a second embodiment of the present invention;

FIG. 7 is a flowchart showing a control operation of the second embodiment of the present invention;

FIG. 8 is a schematic diagram showing the structure of a third embodiment of the present invention;

FIG. 9 is a flowchart showing a control operation of the third embodiment of the present invention;

FIG. 10 is a schematic diagram for explaining a control operation of a communication process between sites according to the third embodiment of the present invention;

FIG. 11 is a flowchart showing the control operation of the communication process between sites according to the third embodiment of the present invention;

FIG. 12 is a schematic diagram showing the structure of a fourth embodiment of the present invention;

FIG. 13 is a flowchart showing a control operation of the fourth embodiment of the present invention; and

FIG. 14 is a schematic diagram for explaining a storage medium that stores a program that accomplishes each embodiment of the present invention.

### DESCRIPTION OF PREFERRED EMBODIMENTS

Next, with reference to the accompanying drawings, embodiments of the present invention will be described.

### Common System Structure of Each Embodiment of the Present Invention

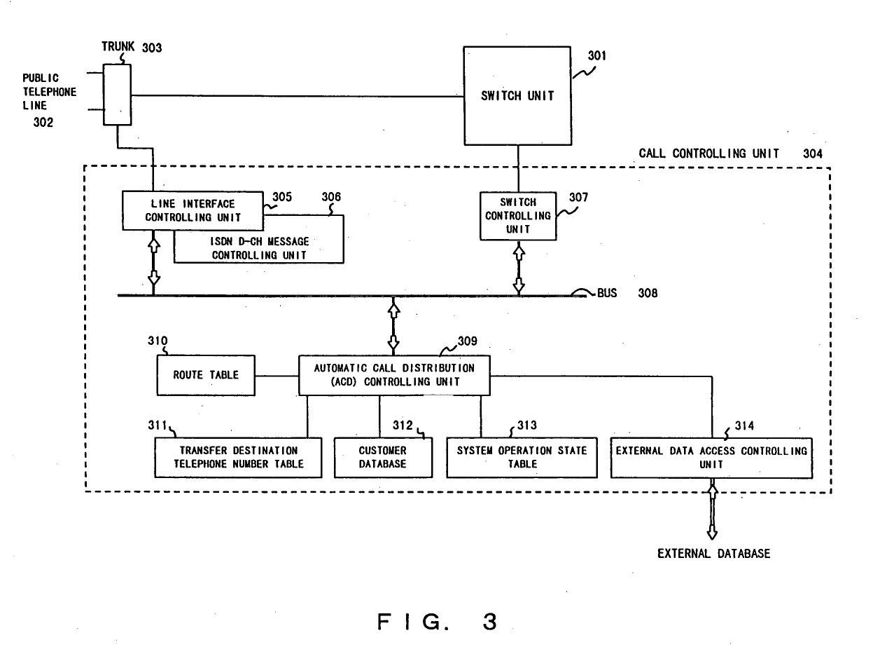

FIG. 3 is a schematic diagram showing the common system structure according to each embodiment of the present invention.

A trunk 303 terminates public telephone lines 302 that are ISDN PRI (Integrated Services Digital Network Primary Rate Interface) lines.

A switch unit 301 switches and connects the public telephone lines 302 which are terminated by a trunk 303 and extension lines connected to ACD agents (not shown).

A call controlling unit 304 controls the switch unit 301 and the trunk 303 and thereby accomplishes a PBX function and an ACD function.

In the call controlling unit 304, a line interface controlling unit 305 terminates a D channel that is a control channel of the ISDN PRI of public telephone lines 302 through the trunk 303.

An ISDN D-CH message controlling unit 306 terminates a D channel message on the D channel that the line interface controlling unit 305 terminates.

A switch controlling unit 307 controls a switch connection state of the switch unit 301.

An automatic call distribution (ACD) controlling unit 309 refers a route table 310, a transfer destination telephone number table 311, a customer database 312, or a system operation state table 313 and accesses an external database of another site through an external data access controlling unit 314. In addition, the ACD controlling unit 309 accesses the D channel of the public telephone lines 302 through the D-CH message controlling unit 306 and the line interface controlling unit 305. Moreover, the ACD controlling unit 309 controls the switch unit 301 through the switch controlling unit 307 and thereby accomplishes an automatic call distribution (ACD) function.

The route table 310 is used in common with all embodiments (first to fifth embodiments) of the present invention. The transfer destination telephone number table 311 is used in the first and fourth embodiments of the present invention. The customer database 312 is used in the second embodiment of the present invention. The system operation state table 313 is used in the third embodiment of the present invention. The external data access controlling unit 314 is used in the third embodiment of the present invention.

### First Embodiment of the Present Invention

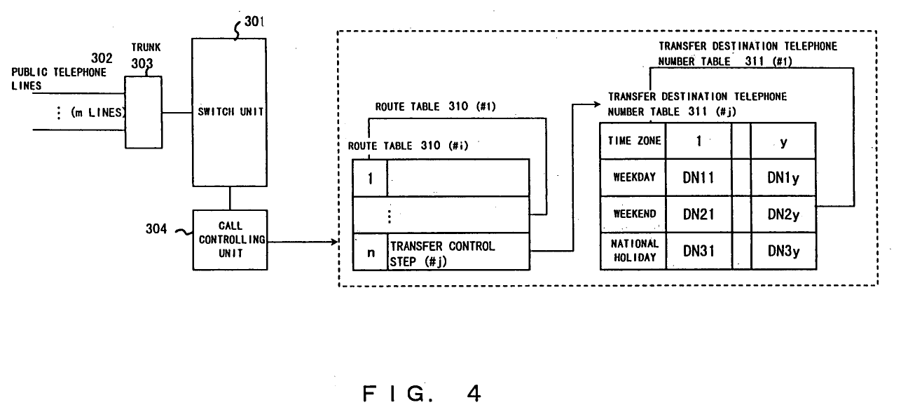

FIG. 4 is a schematic diagram showing the structure according to the first embodiment of the present invention corresponding to the system structure shown in FIG. 3. In FIG. 4, for simplicity, similar units to those of FIG. 3 are denoted by similar reference numerals.

A call controlling unit 304 has a plurality of route tables 310 corresponding to the number of types of termination calls (a guidance process, a support process, a claim process, and so forth).

In addition, the call controlling unit 304 has a plurality of transfer destination telephone number tables 311. Any transfer destination telephone number table 311 (#j) is referred at a transfer control step (#j) in any route table 310.

The transfer control step set in the route table 310 is a call distribution control step for controlling a transfer operation of a termination call through the public telephone network. At the transfer control step in the route table 310, an automatic call distribution controlling unit 309 (see FIG. 3) in the call controlling unit 304 can refer a transfer destination telephone number table 311, determine a transfer destination telephone number, and transfer a termination call received from the public telephone network to another site or a home agent corresponding to the transfer destination telephone number using the termination call transfer service of the public telephone network.

The transfer destination telephone number table 311 is composed of an X×Y matrix of days of week (weekdays, weekends, national holidays, and so forth) and time zones 1 to y. Corresponding to a day of week and a time zone, a transfer destination telephone number DNxy is designated. The transfer destination telephone number DNxy is an optional subscriber telephone number, such as a telephone number on another site, a telephone number of a home agent and so forth.

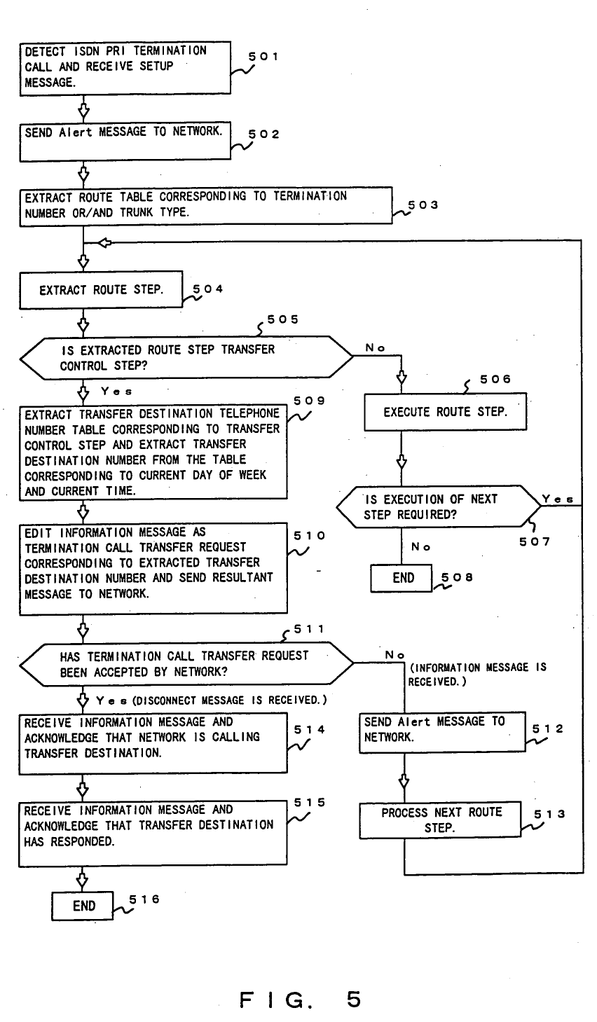

Next, with reference to a flowchart shown in FIG. 5, the operation of the first embodiment of the present invention will be described.

The ISDN D-CH message controlling unit 306 in the call controlling unit 304 receives a SETUP message (at step 501) as an ISDN PRI termination call from the public telephone network through the public telephone line 302, the trunk 303, and the line interface controlling unit 305. The ISDN D-CH message controlling unit 306 notifies the automatic call distribution controlling unit 309 that the ISDN D-CH message controlling unit 306 has received the SETUP message from a particular trunk 303.

The automatic call distribution controlling unit 309 instructs the ISDN D-CH message controlling unit 306 to send an ALERT message to the public telephone network through the line interface controlling unit 305, the trunk 303, and the public telephone line 302 (at step 502).

When the automatic call distribution controlling unit 309 receives notification that represents that the ISDN D-CH message controlling unit 306 has received the SETUP message through the bus 308, the automatic call distribution controlling unit 309 extracts a route table 310 corresponding to a termination number and/or a trunk type contained in the notification (at step 503).

The automatic call distribution controlling unit 309 successively extracts route steps from the beginning of the extracted route table 310 (at step 504) and determines whether or not the extracted route step is a transfer control step (at step 505).

When the extracted route step is not the transfer control step, the automatic call distribution controlling unit 309 executes, for example, the extracted route step for a required control operation (at step 506). Thus, the automatic call distribution controlling unit 309 executes, for example, a call termination controlling operation for any ACD agent (not shown) connected to the switch unit 301, a queuing controlling operation in the case that any ACD agent is busy, a connection controlling operation to an announce machine, or the like corresponding to the extracted route step.

Thereafter, the automatic call distribution controlling unit 309 determines whether or not the execution of the next route step is required (at step 507).

When the execution of the next route step is not required, the automatic call distribution controlling unit 309 terminates the ACD process for the termination call (at steps 507 and 508). When the execution of the next route step is required, the automatic call distribution controlling unit 309 repeats the process for extracting the next route step from the route table 310 extracted at step 503 (at steps 507 and 504).

When the extracted route step is the transfer control step, the automatic call distribution controlling unit 309 extracts a transfer destination telephone number table 311 designated at the transfer control step and extracts a transfer destination telephone number DNxy corresponding to the current day of week and the current time (at steps 505 and 509).

The automatic call distribution controlling unit 309 instructs the ISDN D-CH message controlling unit 306 to edit an INFORMATION message (D channel message) which is a termination call transfer request based on the extracted transfer destination telephone number DNxy and to send the resultant message to the public telephone network through the line interface controlling unit 305, the trunk 303, and the public telephone line 302 (at step 510).

Thereafter, the automatic call distribution controlling unit 309 monitors whether or not the termination call transfer request has been accepted by the public telephone network through the public telephone line 302, the trunk 303, the line interface controlling unit 305, and the ISDN D-CH message controlling unit 306 (at step 511).

As a result of the monitor, when the automatic call distribution controlling unit 309 determines that the termination call transfer request is not accepted by the public telephone network by means of the INFORMATION message received from the public telephone network, the automatic call distribution controlling unit 309 instructs the ISDN D-CH message controlling unit 306 to send the ALERT message to the public telephone network through the line interface controlling unit 305, the trunk 303, and the public telephone line 302 (at steps 511 and 512). Thereafter, the automatic call distribution controlling unit 309 processes the next route step. Thus, the flow returns to step 504 (at steps 513 and 504).

As a result of the monitor, when the automatic call distribution controlling unit 309 determines that the termination call transfer request is accepted by the public telephone network by means of the DISCONNECT message received from the public telephone network, the automatic call distribution controlling unit 309 acknowledges that the public telephone network is calling the transfer destination with the INFORMATION message received from the public telephone network (at steps 511 and 514).

Next, the automatic call distribution controlling unit 309 acknowledges that the transfer destination has responded with the INFORMATION message received from the public telephone network (at step 515) and completes the ACD process for the termination call (at step 516).

Thus, the automatic call distribution controlling unit 309 can refer the transfer destination telephone number table 311 at the transfer control step in the route table 310, determine a transfer destination telephone number, and transfer a termination call received from the public telephone network to another site or a home agent corresponding to the transfer destination telephone number using the termination call transfer service of the public telephone network.

As a result of the ACD process, the public telephone line 302 for the termination call becomes idle.

In addition, the calling subscriber only pays the telephone charge from his or her telephone to a site to which the termination call is received at first. Alternatively, when the telephone number that the subscriber dials is a toll-free number, he or she does not need to pay the telephone charge.

### Second Embodiment of the Present Invention

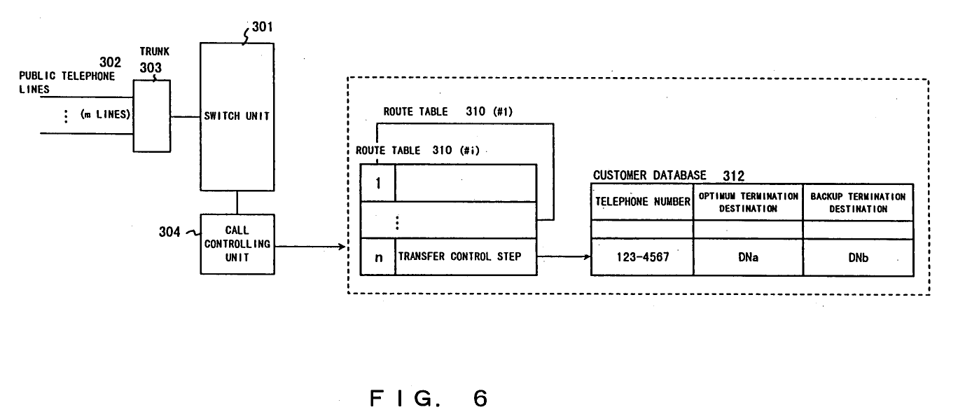

FIG. 6 is a schematic diagram showing the structure according to the second embodiment of the present invention corresponding to the system structure shown in FIG. 3. In FIG. 6, for simplicity, similar units to those of FIG. 3 are denoted by similar reference numerals.

As with the first embodiment shown in FIG. 4, a call controlling unit 304 has a plurality of route tables 310.

In addition, the call controlling unit 304 has a customer database 312. When a transfer control step is extracted from a route table 310, the customer database 312 is referred based on an origination call number (originator's number) added to a termination call. The customer database 312 has an optimum termination destination telephone number DNa and a backup termination destination telephone number DNb (transfer destination) for each record corresponding to each customer telephone number.

When a transfer control step is extracted from a route table 310, an automatic call distribution controlling unit 309 (see FIG. 3) in the call controlling unit 304 can refer a record of the customer database 312 corresponding to an origination call number added to a termination call, extract a backup termination destination telephone number DNb as a transfer destination telephone number, and transfer a termination call received from the public telephone network to another site or a home agent corresponding to the backup termination destination telephone number DNb using the termination call transfer service of the public telephone network.

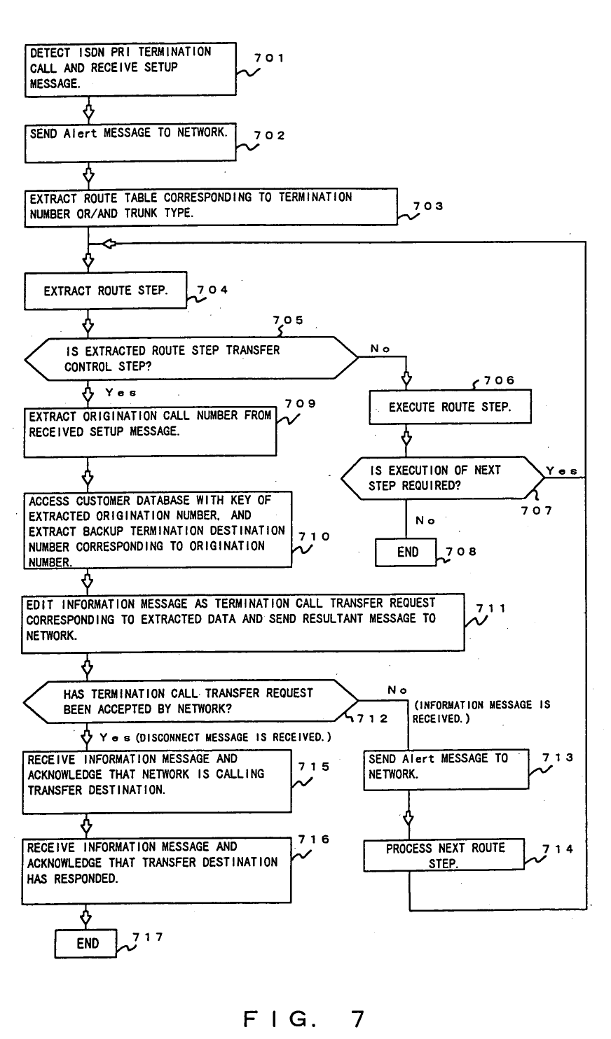

Next, with reference to a flowchart shown in FIG. 7, the operation of the second embodiment will be described.

In FIG. 7, steps 701 to 708 are the same as steps 501 to 508 of the first embodiment shown in FIG. 5, respectively.

When a route step is executed at step 706, an optimum termination destination telephone number DNa in the customer database 312 is constantly referenced. Thus, an optimum ACD agent (extension line) on the local site is determined.

When the automatic call distribution controlling unit 309 successively extracts route steps from a route table 310 corresponding to a termination call or the type of the trunk 303, if the extracted route step is a transfer control step, the automatic call distribution controlling unit 309 extracts an origination call number (originator's number) from a SETUP message of a termination call received at step 701 (at step 709).

Next, the automatic call distribution controlling unit 309 accesses the customer database 312 with a key of the extracted origination call number and extracts a backup termination destination telephone number DNb as a transfer destination telephone number from a record corresponding to the origination call number (at step 710).

The automatic call distribution controlling unit 309 instructs the ISDN D-CH message controlling unit 306 to edit an INFORMATION message that is a termination call transfer request based on the extracted backup termination destination telephone number DNb and to send the resultant message to the public telephone network through the line interface controlling unit 305, the trunk 303, and the public telephone line 302 (at step 711).

Steps 712 to 717 in FIG. 7 are the same as steps 511 to 516 of the first embodiment shown in FIG. 5, respectively.

Thus, when the automatic call distribution controlling unit 309 extracts a transfer control step from the route table 310, the automatic call distribution controlling unit 309 can refer a record of the customer database 312 corresponding to an origination call number added to a termination call, extract a backup termination destination telephone number DNb as a transfer destination telephone number, and transfer a termination call received from the public telephone network to another site or a home agent corresponding to the backup termination destination telephone number DNb using the termination call transfer service of the public telephone network.

### Third Embodiment of the Present Invention

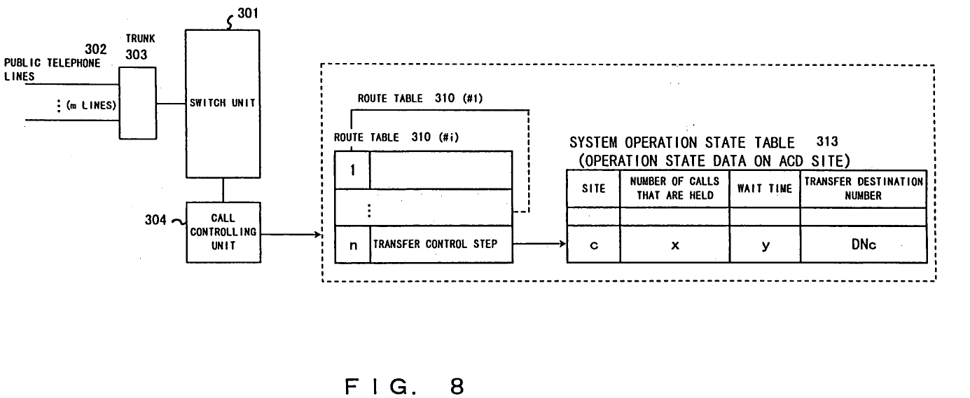

FIG. 8 is a schematic diagram showing the structure according to the third embodiment of the present invention based on the system structure shown in FIG. 3. In FIG. 8, for simplicity, similar units to those in FIG. 3 are denoted by similar reference numerals.

As with the first embodiment shown in FIG. 4, a call controlling unit 304 has a plurality of route tables 310.

In addition, the call controlling unit 304 has a system operation state table 313. The system operation state table 313 stores an operation state of each record corresponding to each ACD group of each site (ACD site) when the transfer control step is extracted from the route table 310.

An ACD group is a group of ACD agents to which a termination call of a particular type can be terminated on one site.

As an operation state of each ACD group on each ACD site, the number of calls that are queued in the ACD group on the site, wait time, the transfer destination telephone number DNc that is the representative telephone number of the site, and so forth are designated. The operation state of each ACD group on each ACD site can be updated on real time basis by a communication process performed between sites. The communication process will be described later.

The operation state of each ACD group on the local site is stored in the system operation state table 313 on the local site.

When an automatic call distribution controlling unit 309 (see FIG. 3) in the call controlling unit 304 extracts a transfer control step from the route table 310, the automatic call distribution controlling unit 309 can refer the system operation state table 313, determine an optimum transfer destination site and ACD group, extract a transfer destination telephone number DNc corresponding to the optimum transfer site and ACD group, and transfer a termination call received from the public telephone network to another site or a home agent corresponding to the transfer destination telephone number DNc using the termination call transfer service of the public telephone network.

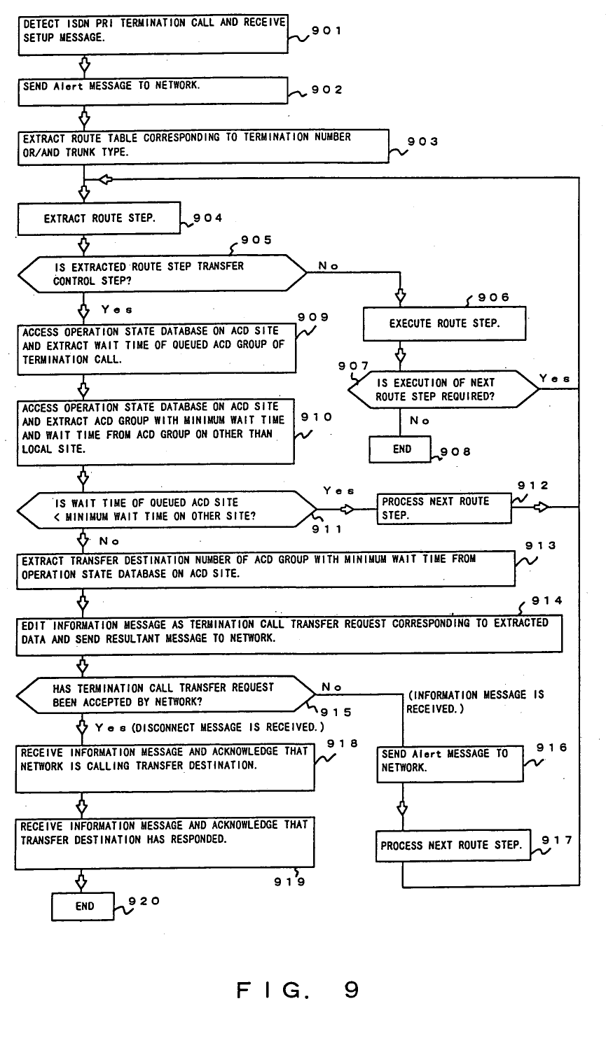

Next, with reference to a flowchart shown in FIG. 9, the operation of the third embodiment of the present invention will be described.

Steps 901 to 908 shown in FIG. 9 are the same as steps 501 to 508 of the first embodiment shown in FIG. 5, respectively.

When the automatic call distribution controlling unit 309 successively extracts route steps from the route table 310 corresponding to a termination call or the type of the trunk 303, if the extracted route step is a transfer control step, the automatic call distribution controlling unit 309 refers the system operation state table 313 and extracts wait time from a record corresponding to a queued ACD group on the local site (at step 909).

In addition, the automatic call distribution controlling unit 309 refers the system operation state table 313 and extracts a record of an ACD group of which the wait time is the minimum and the wait time thereof from a record corresponding to each ACD group on each site other than the local site (at step 910).

The automatic call distribution controlling unit 309 determines whether or not the wait time of the queued ACD group extracted at step 909 is smaller than the minimum wait time of the other site extracted at step 910 (at step 911).

When the determined result at step 911 is Yes, the automatic call distribution controlling unit 309 processes the next route step. Thus, the flow returns to step 904 (at steps 911, 912, and 914).

On the other hand, when the determined result at step 911 is No, the automatic call distribution controlling unit 309 refers the system operation state table 313 and extracts a transfer destination telephone number DNc corresponding to an ACD group on other site corresponding to the record that has the minimum wait time and that is extracted at step 910 (at steps 911 and 913).

The automatic call distribution controlling unit 309 instructs the ISDN D-CH message controlling unit 306 to edit an INFORMATION message that is a termination call transfer request based on the extracted transfer destination telephone number DNc and to send the resultant message to the public telephone network through the line interface controlling unit 305, the trunk 303, and the public telephone line 302 (at step 914).

Steps 915 to 920 shown in FIG. 9 are the same as steps 511 to 516 of the first embodiment shown in FIG. 5, respectively.

When the automatic call distribution controlling unit 309 extracts a transfer control step from a route table 310, the automatic call distribution controlling unit 309 can reference the system operation state table 313, determine an optimum transfer destination site and ACD group, extract a transfer destination telephone number DNc corresponding to the optimum transfer destination site and ACD group, and transfer a termination call received from the public telephone network to another site or a home agent corresponding to the transfer destination telephone number DNc using the termination call transfer service of the public telephone network.

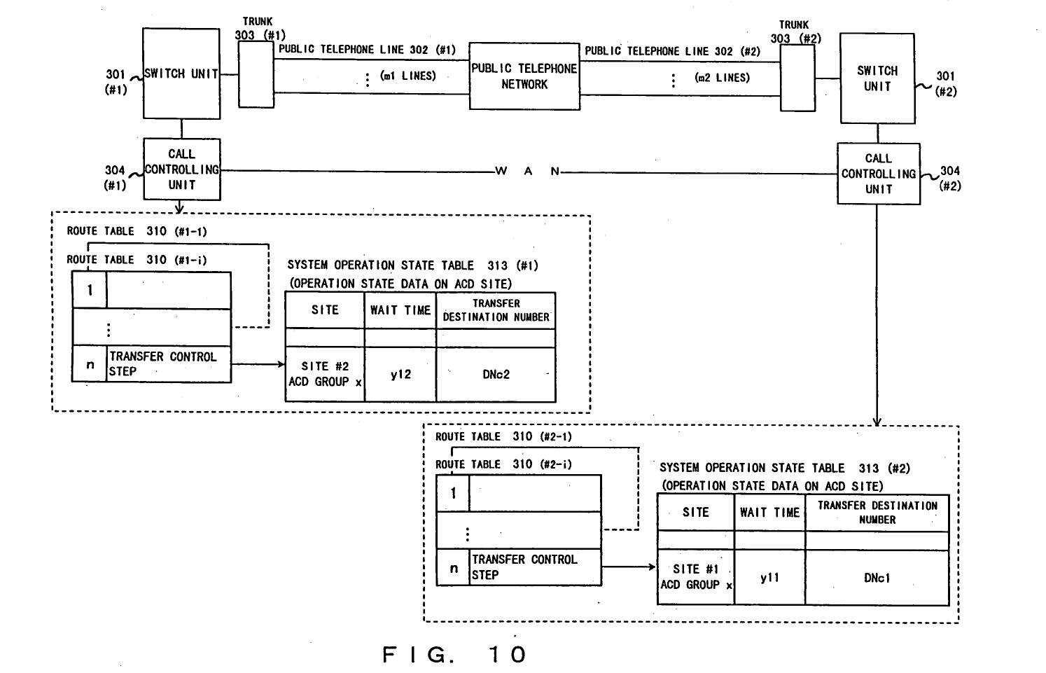

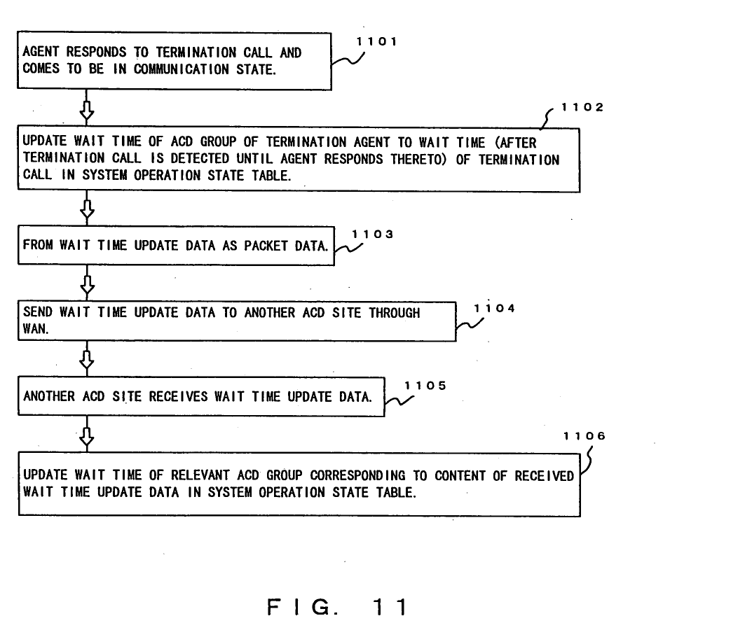

FIG. 10 is a schematic diagram for explaining a control operation of a communication process performed in real time between sites for exchanging an operation state of each ACD group on each ACD site. FIG. 11 is a flowchart showing the control operation of FIG. 10.

On an ACD site (#1), an ACD agent (not shown) accommodated in a switch unit 301 (#1) on the site responds to a termination call and comes to be communication state (at step 1101 in FIG. 11).

An automatic call distribution controlling unit 309 (see FIG. 3) in a call controlling unit 304 (#1) on the ACD site (#1) updates a wait time of a record corresponding to an ACD group of the termination agent to the wait time (time after a termination call is detected until the ACD agent responds thereto) of the termination call in a system operation state table 313 (at step 1102).

The automatic call distribution controlling unit 309 sends the wait time update data as packet data from an external data access controlling unit 314 (see FIG. 3) to another site (for example, a site (#2) of a switch unit 301 (#2) shown in FIG. 10) through a WAN (Wide Area Network) that is a computer network (at steps 1103 and 1104).

On the other hand, an automatic call distribution controlling unit 309 in a call controlling unit 304 (#2) on a site (#2) receives the packet data through the external data access controlling unit 314 (at step 1105).

The automatic call distribution controlling unit 309 in the call controlling unit 304 (#2) on the site (#2) updates the wait time of a record of the ACD group in the system operation state table 313 corresponding to the content of the wait time update data in the packet data (at step 1106).

The communication process performed between ACD sites may be executed at intervals of a predetermined time period rather than a discrete timing of which an ACD agent on each ACD site responds to a termination call.

### Fourth Embodiment of the Present Invention

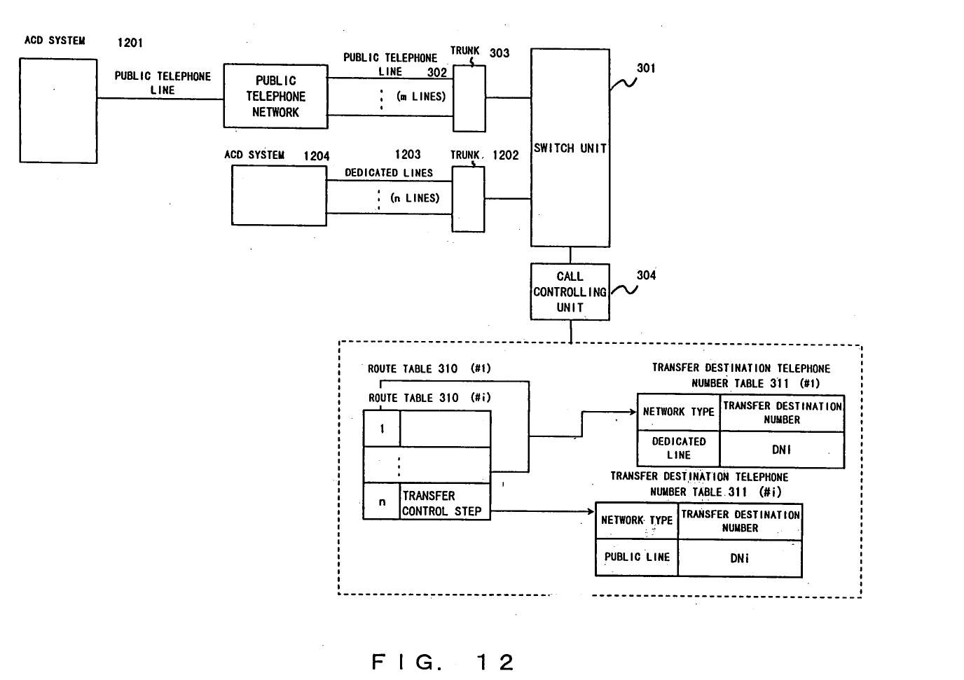

FIG. 12 is a schematic diagram showing the structure according to the fourth embodiment of the present invention corresponding to the system structure shown in FIG. 3. In FIG. 12, for simplicity, similar units to those in FIG. 3 are denoted by similar reference numerals.

As with the first embodiment of the present invention shown in FIG. 4, the call controlling unit 304 has a plurality of route tables 310.

In addition, the call controlling unit 304 has a plurality of transfer destination telephone number tables 311 that register network types for distinguishing a public telephone network from a dedicated network such as a toll network and transfer destination telephone numbers on the distinguished networks.

An automatic call distribution controlling unit 309 (see FIG. 3) in the call controlling unit 304 refers a transfer destination telephone number table 311 designated at a transfer control step in a route table 310 and determines a network type and a transfer destination telephone number. When the network type is a public telephone network, as with the first embodiment of the present invention, the automatic call distribution controlling unit 309 can transfer a termination call received from the public telephone network to another site or a home agent corresponding to the transfer destination telephone number using the termination call transfer service of the public telephone network. When the network type is a dedicated network, after acquiring a trunk 1202, the automatic call distribution controlling unit 309 can originate a call to the telephone number of a ACD system 1204 as a transfer destination through a dedicated line 1203 and transfer a termination call received from the public telephone network to another site or a home agent corresponding to the transfer destination telephone number.

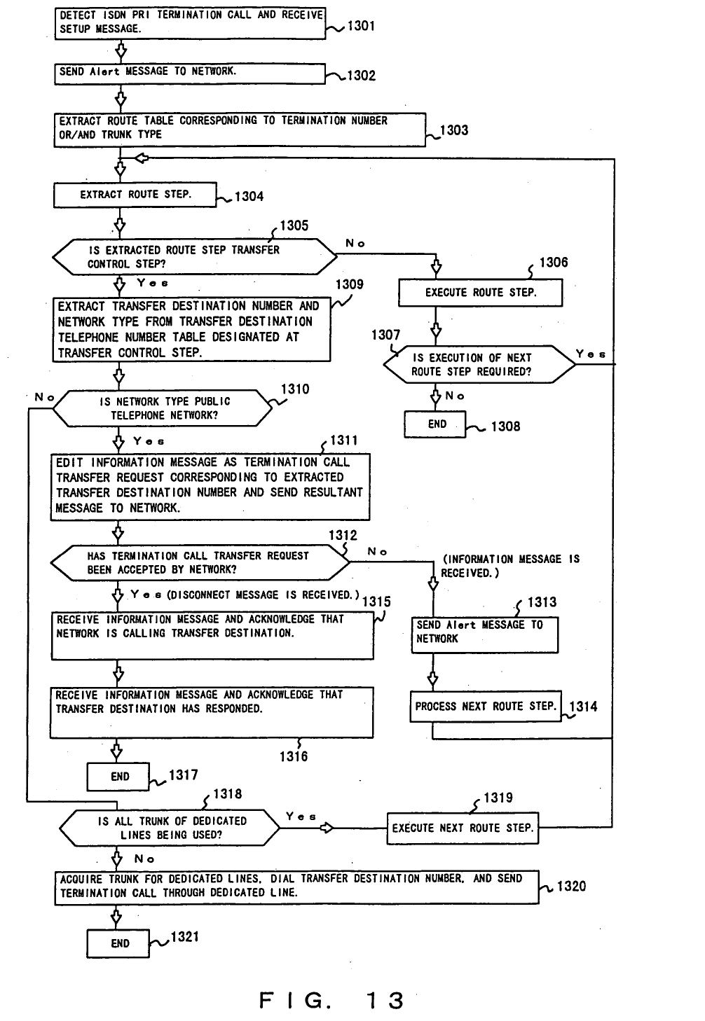

Next, with reference to a flowchart shown in FIG. 13, the operation of the fourth embodiment of the present invention will be described.

Steps 1301 to 1308 shown in FIG. 13 are the same as steps 501 to 508 of the first embodiment shown in FIG. 5, respectively.

When the automatic call distribution controlling unit 309 successively extract route steps from a route table 310 corresponding to a termination call or the type of the trunk 303, if the extracted route step is a transfer control step, the automatic call distribution controlling unit 309 extracts a transfer destination telephone number and a network type from a transfer destination telephone number table 311 designated at the transfer control step (at step 1309).

The automatic call distribution controlling unit 309 determines whether or not the extracted network type is a public telephone network (at step 1310).

When the automatic call distribution controlling unit 309 determines the extracted network type is a public telephone network, the automatic call distribution controlling unit 309 executes steps 1311 to 1317 that are the same as steps 510 to 516 of the first embodiment shown in FIG. 5, respectively.

Thus, when the network type is a public telephone network, as with the first embodiment, the automatic call distribution controlling unit 309 can transfer a termination call received from the public telephone network to another site or a home agent corresponding to the transfer destination telephone number using the termination call transfer service of the public telephone network.

When the extracted network type is a dedicated network rather than a public telephone network, the automatic call distribution controlling unit 309 executes steps 1318 to 1321.

The automatic call distribution controlling unit 309 determines whether or not all the trunks 1202 accommodating the dedicated lines 1203 (see FIG. 12) are used (at step 1318).

When the automatic call distribution controlling unit 309 determined all the trunks 1202 are used, the automatic call distribution controlling unit 309 processes the next route step. Thus, the flow returns to step 1304 (at steps 1318, 1319, and 1304).

When the automatic call distribution controlling unit 309 determined all the trunks 1202 are not used, the automatic call distribution controlling unit 309 acquires the trunk 1202 for the dedicated lines 1203, originates (dials) a call the transfer destination telephone number extracted at step 1309, transfers a termination call received from the public telephone network to another ACD system 1204 corresponding to the transfer destination telephone number (at step 1320), and terminates the ACD process (at step 1321).

Thus, when the network type is a dedicated network, the automatic call distribution controlling unit 309 can originate a call to the transfer destination telephone number through a dedicated line 1203 and transfers a termination call received from the public telephone network to another site corresponding to the transfer destination telephone number.

### Supplementary Explanation of a Storage Medium Storing a Program for Accomplishing the Embodiments of the Present Invention

The present invention can be applied to a storage medium from which a computer reads a program that performs the functions of the above-described embodiments.

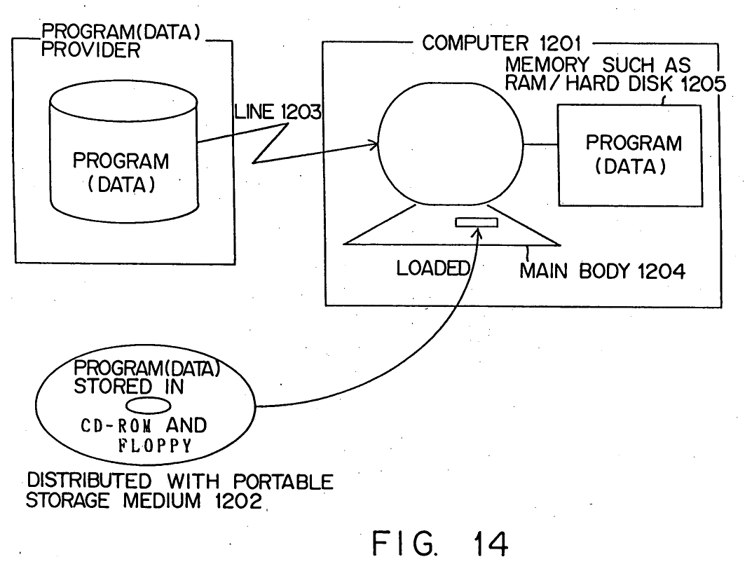

In this case, as shown in FIG. 14, a program that accomplishes each of the above-described embodiments of the present invention is loaded to a memory (a RAM, a hard disk or the like) in a main body 1404 of a computer 1401 that realizes the call controlling unit 304 shown in FIG. 3, from a portable storage medium 1402 such as a floppy disk, a CD-ROM disc, an optical disc, or a removable disc, or through a network line 1403, and then the program is executed.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A call center apparatus for automatically distributing a call through a public telephone network, comprising:
a route table for storing at least one control step for controlling an automatic call distributing process for a termination call; and
a call controlling processor for executing an automatic call distributing operation corresponding to each control step, when the executed control step is a transfer control step for instructing to transfer the termination call, determining a transfer destination telephone number for the termination call designated at the transfer control step, and transferring the termination call to the determined transfer destination telephone number using a termination call transfer service of the public telephone network by successively executing each control step in said route table for a termination call.

2. The apparatus as set forth in claim 1,
wherein when the executed control step is a transfer control step for instructing to transfer the termination call and when the transfer destination telephone number for the termination call designated at the transfer control step is corresponding to a private telephone network other than the public telephone network, said call controlling processor originates a call to the transfer destination telephone number on the private telephone network and transfers the termination call received from the public telephone network to the transfer destination telephone number on the private telephone network.

3. The apparatus as set forth in claim 1, further comprising:
a transfer destination telephone number table for storing information with which a transfer destination telephone number is designated,
wherein when the executed control step is a transfer control step for instructing to transfer the termination call, said call controlling processor refers the transfer destination telephone number table, determines a transfer destination telephone number for the termination call, and transfers the termination call to the determined transfer destination telephone number using the termination call transfer service of the public telephone network.

4. The apparatus as set forth in claim 3,
wherein when the executed control step is a transfer control step for instructing to transfer the termination call and when the transfer destination telephone number for the termination call designated at the transfer control step is corresponding to a private telephone network other than the public telephone network, said call controlling processor originates a call to the transfer destination telephone number on the private telephone network and transfers the termination call received from the public telephone network to the transfer destination telephone number on the private telephone network.

5. The apparatus as set forth in claim 3,
wherein the transfer destination telephone number table stores information with which the transfer destination telephone number is scheduled corresponding to date, day of week, or time zone.

6. The apparatus as set forth in claim 5,
wherein when the executed control step is a transfer control step for instructing to transfer the termination call and when the transfer destination telephone number for the termination call designated at the transfer control step is corresponding to a private telephone network other than the public telephone network, said call controlling processor originates a call to the transfer destination telephone number on the private telephone network and transfers the termination call received from the public telephone network to the transfer destination telephone number on the private telephone network.

7. The apparatus as set forth in claim 1, further comprising:
an additional information database for storing information with which the transfer destination telephone number is designated based on additional information that is added to said termination call by the public telephone network,
wherein when the executed control step is a transfer control step for instructing to transfer the termination call, said call controlling processor refers the additional information database based on the additional information added to the termination call, determines a transfer destination telephone number for the termination call, and transfers the termination call to the determined transfer destination telephone number using the termination call transfer service of the public telephone network.

8. The apparatus as set forth in claim 7,
wherein when the executed control step is a transfer control step for instructing to transfer the termination call and when the transfer destination telephone number for the termination call designated at the transfer control step is corresponding to a private telephone network other than the public telephone network, said call controlling processor originates a call to the transfer destination telephone number on the private telephone network and transfers the termination call received from the public telephone network to the transfer destination telephone number on the private telephone network.

9. The apparatus as set forth in claim 1, further comprising:
a system operation state table for storing a system operation state of another call center apparatus,
wherein when the executed control step is a transfer control step for instructing to transfer the termination call, said call controlling processor refers the system operation state table, determines an optimum transfer destination telephone number for the termination call, and transfers the termination call to the determined transfer destination telephone number using the termination call transfer service of the public telephone network.

10. The apparatus as set forth in claim 9,
wherein when the executed control step is a transfer control step for instructing to transfer the termination call and when the transfer destination telephone number for the termination call designated at the transfer control step is corresponding to a private telephone network other than the public telephone network, said call controlling processor originates a call to the transfer destination telephone number on the private telephone network and transfers the termination call received from the public telephone network to the transfer destination telephone number on the private telephone network.

11. The apparatus as set forth in claim 9, further comprising:
a system operation state communication circuit for communicating the system operation state between the call center apparatus and another call center apparatus.

12. The apparatus as set forth in claim 11,
wherein when the executed control step is a transfer control step for instructing to transfer the termination call and when the transfer destination telephone number for the termination call designated at the transfer control step is corresponding to a private telephone network other than the public telephone network, said call controlling processor originates a call to the transfer destination telephone number on the private telephone network and transfers the termination call received from the public telephone network to the transfer destination telephone number on the private telephone network.

13. A call center controlling method for automatically distributing a call through a public telephone network, comprising the steps of:
storing at least one control step for controlling an automatic call distributing process for a termination call to a route table; and
by successively executing each control step in said route table for a termination call, executing an automatic call distributing operation corresponding to each control step, when the executed control step is a transfer control step for instructing to transfer the termination call, determining a transfer destination telephone number for the termination call designated at the transfer control step, and transferring the termination call to the determined transfer destination telephone number using a termination call transfer service of the public telephone network.

14. The method as set forth in claim 13, further comprising the steps of:
storing information with which a transfer destination telephone number is designated to a transfer destination telephone number table; and
when the executed control step is a transfer control step for instructing to transfer the termination call, referring the transfer destination telephone number table, determining a transfer destination telephone number for the termination call, and transferring the termination call to the determined transfer destination telephone number using the termination call transfer service of the public telephone network.

15. The method as set forth in claim 13,
wherein the transfer destination telephone number table stores information with which the transfer destination telephone number is scheduled corresponding to date, day of week, and time zone.

16. The method as set forth in claim 13, further comprising the steps of:
storing information with which the transfer destination telephone number is designated based on additional information that is added to the termination call by the public telephone network to an additional information database; and
when the executed control step is a transfer control step for instructing to transfer the termination call, referring the additional information database based on the additional information added to the termination call, determining a transfer destination telephone number for the termination call, and transferring the termination call to the determined transfer destination telephone number using the termination call transfer service of the public telephone network.

17. The method as set forth in claim 13, further comprising the steps of:
storing a system operation state of another call center apparatus to a system operation state table; and
when the executed control step is a transfer control step for instructing to transfer the termination call, referring the system operation state table, determining an optimum transfer destination telephone number for the termination call, and transferring the termination call to the determined transfer destination telephone number using the termination call transfer service of the public telephone network.

18. The method as set forth in claim 17, further comprising the step of:
communicating the system operation state-between the call center apparatus and another call center apparatus.

19. The method as set forth in claim 13, further comprising the step of:
when the executed control step is a transfer control step for instructing to transfer the termination call and when the transfer destination telephone number for the termination call designated at the transfer control step is corresponding to a private telephone network other than the public telephone network, originating a call to the transfer destination telephone number on the private telephone network and transferring the termination call received from the public telephone network to the transfer destination telephone number on the private telephone network.

20. A storage medium from which a computer for controlling a call center apparatus for automatically distributing a call through a public telephone network to perform the functions of:
storing at least one control step for controlling an automatic call distributing process for a termination call; and
by successively executing each stored control step for a termination call, executing an automatic call distributing operation corresponding to each control step, when the executed control step is a transfer control step for instructing to transfer the termination call, determining a transfer destination telephone number for the termination call designated at the transfer control step, and transferring the termination call to the determined transfer destination telephone number using a termination call transfer service of the public telephone network.
